(19) United States
(12) Patent Application Publication
(10) Pub. No.: US 2026/0356061 A1
(43) Pub. Date: Nov. 12, 2026

(54) METHOD OF MANUFACTURING SELF-FORMING OPTICAL WAVEGUIDE

(71) Applicants: NATIONAL UNIVERSITY CORPORATION UTSUNOMIYA UNIVERISITY, Tochigi (JP); ORBRAY CO., LTD., Tokyo (JP)

(72) Inventors: Okihiro SUGIHARA, Tochigi (JP); Hidetaka TERASAWA, Tochigi (JP); Tsuyoshi NAMEKAWA, Tokyo (JP)

(73) Assignees: NATIONAL UNIVERSITY CORPORATION UTSUNOMIYA UNIVERSITY, Tochigi (JP); ORBRAY CO., LTD., Tokyo (JP)

(21) Appl. No.: 19/131,074

(22) PCT Filed: Nov. 21, 2023
(86) PCT No.: PCT/JP2023/041697

§ 371 Date: May 19, 2025

(30) Foreign Application Priority Data
Nov. 21, 2022 (JP) 2022-185654

(51) Int. Cl. B29D 11/00; G02B 6/02; G02B 6/26; G02B 6/38

(52) U.S. Cl. CPC B29D 11/00663; G02B 6/262; G02B 6/3801; G02B 6/02042

(57) ABSTRACT

A method of manufacturing a self-forming optical waveguide employing self-forming. Two multi-core fibers, each of which includes a photocurable resin and n cores (n=a 2 or greater natural number). The photocurable resin includes: a core portion forming resin which has a refractive index of na after polymerization and curing by irradiation of light of a predetermined wavelength band; and a clad portion forming resin which has a refractive index of nb, satisfying nb<na, after polymerization and curing by irradiation of light having an intensity equal to or higher than the intensity of the light irradiating the core portion forming resin. The two multi-core fibers face each other and the photocurable resin is between the multi-core fibers. Light is caused to irradiate from the cores of the multi-core fibers sequentially to the photocurable resin, to form the core portion. Then, the clad portion is formed.

### CROSS-REFERENCE TO RELATED APPLICATIONS

This application claims priority to Japanese Patent Application No. 2022-185654 filed on Nov. 21, 2022, which is expressly incorporated herein by reference in its entirety.

### TECHNICAL FIELD

The present invention relates to a method of manufacturing a self-forming optical waveguide.

### BACKGROUND ART

While the fields of utilizing optical technology, such as optical communication, optical information processing, electronic devices and optical devices, are advancing, development of optical waveguides used among various optical devices have issues. Various optical devices are optically connected via optical waveguides, for example, optical fiber, and extremely high positional precision is required for this connection. Conventionally, this connection operation has been performed manually or by high precision aligning equipment, which makes connection costs high.

To solve this problem, a self-forming optical waveguide has been developed. This optical waveguide is an optical waveguide of which core is self-formed from photocurable resin. An end of an optical fiber or the like is dipped into the photocurable resin, then light is caused to enter the photocurable resin through the optical fiber or the like so that the photocurable resin is gradually cured, whereby a self-forming optical waveguide is formed on the end of the optical fiber or the like.

A self-forming optical waveguide like this is disclosed in WO 2020/209364, which is expressly incorporated herein by reference in its entirety. According to WO 2020/209364, an optical connector includes at least a ferrule and n number (n: a natural number excluding 0) of self-forming optical waveguides. The ferrule includes n number of optical fiber insertion holes, and an optical fiber is inserted into each optical fiber insertion hole.

The optical waveguide that has been formed is left alone for 2 minutes so as to promote inter-diffusion of monomers at a core-clad interface, then the clad is formed by UV radiation. Out of the photocurable resin, only one side of the monomers in the core region is consumed and polymerized, hence the concentration gradient of monomers is generated and the inter-diffusion progresses at the core-clad interface, which fulfills the function of the clad. Further, by applying the UV on the entire photocurable resin, the core and clad are totally cured, and the optical waveguide is acquired thereby.

### SUMMARY OF INVENTION

However in the case of forming a plurality of self-forming optical waveguides as disclosed in WO 2020/209364, if light is simultaneously applied into the photocurable resin from a core of each optical fiber, each self-forming optical waveguide, formed by the light applied to adjacent cores, may bond with each other, which may cause a bonding failure.

With the foregoing in view, it is an object of the present invention to implement a method of manufacturing a self-forming optical waveguide which can prevent bonding failure.

The above problem is solved by the present invention described below. That is, in the method of manufacturing a self-forming optical waveguide of the present invention, two multi-core fibers, each of which includes a photocurable resin and n number (n: 2 or greater natural number) of cores, are prepared. The photocurable resin includes: a core portion forming resin which has a refractive index of na after polymerization and curing by irradiation of light in a predetermined wavelength band; and a clad portion forming resin which has a refractive index of nb, satisfying nb<na, after polymerization and curing by irradiation of light having an intensity equal to or higher than the intensity of the light irradiating into the core portion forming resin. The two multi-core fibers are disposed to face each other, and the photocurable resin is disposed between the multi-core fibers. Light having intensity that can polymerize only the core portion forming resin is caused to irradiate into the photocurable resin from the two multi-core fibers sequentially, so that the core portion forming resin is polymerized and cured to form a core portion of the optical waveguide inside the photocurable resin. Then, a clad portion is formed, and n number of optical waveguides are self-formed inside the photocurable resin.

By the method of manufacturing a self-forming optical waveguide according to the present invention, it can be prevented that each core portion, which is formed by light radiation between adjacent cores in each multi-core fiber, is formed in a state of bonding with each other, hence the bonding failure of the core portions can be prevented.

### BRIEF DESCRIPTION OF DRAWINGS

FIG. 1 is a front view depicting a configuration of a multi-core fiber used in a method of manufacturing a self-forming optical waveguide according to an example of the present invention.

FIG. 2 is a diagram depicting a part of a state where a photocurable resin is disposed between two multi-core fibers in the method of manufacturing a self-forming optical waveguide according to an example of the present invention.

FIG. 3 is a diagram depicting a state where light is irradiated into the photocurable resin from each core of the two multi-core fibers, from the state in FIG. 2, and the core portion of the self-forming optical waveguide is formed thereby.

FIG. 4 is a perspective view depicting the state in FIG. 3, omitting the photocurable resin and a transparent container.

FIG. 5 is a diagram depicting a state where light is irradiated into the core portion and is propagated, and light leakage is generated from each core portion, from the state of FIG. 3.

FIG. 6 is a diagram depicting a state where each clad portion and a plurality of self-forming optical waveguides are generated, from the state in FIG. 5.

FIG. 7 is a stereo-microscopic observation image indicating the state in FIG. 6.

### DESCRIPTION OF EMBODIMENTS

In the method of manufacturing a self-forming optical waveguide of the present invention, two multi-core fibers, each of which includes a photocurable resin and n number (n: 2 or greater natural number) of cores, are prepared. The photocurable resin includes: a core portion forming resin which has a refractive index of na after polymerization and curing by irradiation of light in a predetermined wavelength band; and a clad portion forming resin which has a refractive index of nb, satisfying nb<na, after polymerization and curing by irradiation of light having an intensity equal to or higher than the intensity of the light irradiating into the core portion forming resin. The two multi-core fibers are disposed to face each other, and the photocurable resin is disposed between the multi-core fibers. Light (hereafter also simply called “light”) having intensity that can polymerize only the core portion forming resin is caused to irradiate into the photocurable resin from the two multi-core fibers sequentially, so that the core portion forming resin is polymerized and cured to form a core portion of the optical waveguide inside the photocurable resin. Then, a clad portion is formed, and n number of optical waveguides are self-formed inside the photocurable resin.

In the above manufacturing method, light having intensity that can polymerize only the core portion forming resin can be irradiated into the photocurable resin from the cores of the multi-core fiber sequentially.

According to the above manufacturing method, it can be prevented that each core portion, which is formed by light radiation between adjacent cores in each multi-core fiber, is formed in a state of bonding with each other, hence bonding failure of the core portions can be prevented.

### EXAMPLE

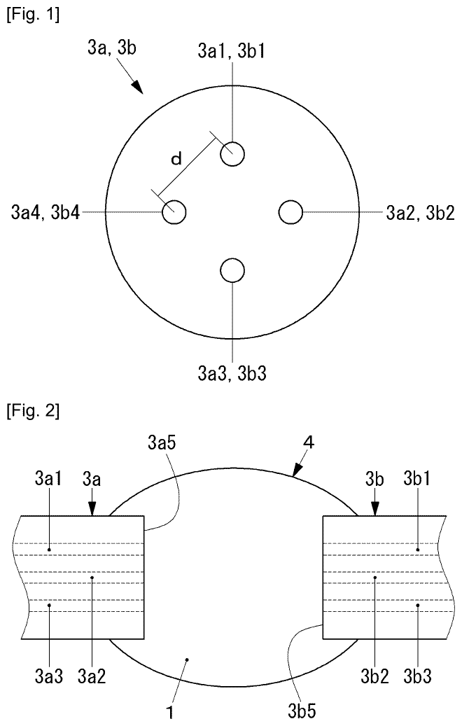

A manufacturing method according to an example will be described with reference to FIGS. 1 to 7 as an aspect of the present invention, but the present invention is not limited to the following example.

In the manufacturing method of the present example, multi-core fibers (3a, 3b), each of which includes photocurable resin 1 and n number (n: 2 or greater natural number) of cores, are prepared first. As the multi-core fibers (3a, 3b), two multi-core fibers having a same structure are prepared. n is 2 or greater natural number, and is 2 or more and 4 or less, for example. n, however, is not limited to the range exemplified above.

The photocurable resin 1 is filled in a transparent container 4, and an end on one side of each multi-core fiber (3a, 3b) is dipped into the photocurable resin 1 respectively. This means that the photocurable resin 1 is disposed between the multi-core fibers (3a, 3b), and the two multi-core fibers (3a, 3b) are disposed to face each other with the photocurable resin 1 therebetween.

Each of the two multi-core fibers (3a, 3b) has a circular outer shape, as illustrated in FIG. 1, the core diameter of which is 8.0 μm, and the clad diameter of which is 125 μm, and includes four cores (n=4) (3a1, 3a2, 3a3, 3a4, or 3b1, 3b2, 3b3 and 3b4). The four cores (3a1 to 3a4, or 3b1 to 3b4) are disposed on the circumference of a circle centered at the center of the multi-core fiber (3a, 3b), and are disposed at equal angle intervals (90° in FIG. 1), and are evenly spaced to be 2 rows×2 cores, as illustrated in FIG. 1. In the present example, in the two multi-core fibers (3a, 3b), distance d between each core (3a1 to 3a4 or 3b1 to 3b4) is 50 μm. The distance d is a distance between the centers of the two adjacent cores.

For example, the cutoff wavelength is 1300 nm to 1500 nm, and the mode field diameter is 7.4 μm to 8.5 μm (propagation light wavelength: 1550 nm).

The end faces (3a5, 3b5) of the multi-core fibers (3a, 3b) which were dipped into the photocurable resin 1 are formed in a plane shape, so as to be vertical to the optical axis direction of each core (3a1 to 3a4, or 3b1 to 3b4), as illustrated in FIG. 2. The end faces (3a5, 3b5) are surface-polished.

The photocurable resin 1 includes a core portion forming resin and a clad portion forming resin. The core portion forming resin has a refractive index of na after polymerization and curing by irradiation of light in a predetermined wavelength band. The clad portion forming resin is polymerized and cured by irradiation of light in a wavelength band the same as or different from the wavelength band of light that irradiates the core portion forming resin, and has intensity equal to or higher than the intensity of light that irradiates the core portion forming resin. The refractive index nb of the clad portion forming resin after curing satisfies nb<na.

As the core portion forming resin and the clad portion forming resin, resins which are photo-polymerized through polymerization reaction are different from each other. In the present example, the core portion forming resin is an acrylic resin, and the clad portion forming resin is an epoxy resin. In a combination of the acrylic resin and the epoxy resin, the polymerization reaction speed is faster in the acrylic resin than in the epoxy resin, hence the acrylic resin is selectively polymerized by low intensity light.

The acrylic resin and the epoxy resin are solutions prepared by adding photo-polymerization initiator to a mixed solution constituted of two types or more of monomers.

Then light in a predetermined wavelength band is irradiated into the photocurable resin 1 through the cores (3a1 to 3a4 or 3b1 to 3b4) of the two multicore fibers (3a, 3b). The light that irradiates into the photocurable resin 1 is a laser beam, the intensity of which allows polymerization only for the core portion forming resin. The wavelength λw of the light can be freely set in accordance with the photo-polymerization initiator, in a 365 nm to 1675 nm range, for example, and is set to λw=405 nm in the present example. Hence the wavelength band at which the photo-polymerization initiator has sensitivity is also set to around 405 nm.

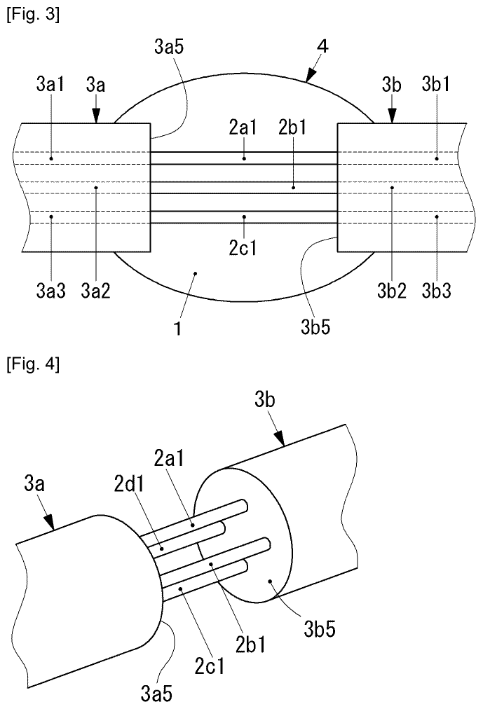

By irradiation with the light from the cores (3a1 to 3a4, or 3b1 to 3b4), the core portion forming resin is polymerized and cured, and the monomers of the core portion forming resin become a polymer, and a plurality of core portions (2a1, 2b1, 2c1, 2d1) of the optical waveguides are self-formed in the photocurable resin 1, as illustrated in FIGS. 3 and 4.

When the light irradiates from the cores (3a1 to 3a4 or 3b1 to 3b4) into the photocurable resin 1, the light is irradiated into the n number of cores sequentially in each multicore fiber (3a, 3b). “Sequentially” here means that when light is sequentially entered into the n number of cores in each multicore fiber (3a, 3b), light is not entered into any other cores of this multicore fiber, while light is being entered into one core. For example, in the multicore fiber 3a, light is not entered into the cores 3a2, 3a3 and 3a4 while light is being entered into the core 3a1, and in the multicore fiber 3b, light is not entered into the cores 3b2, 3b3 and 3b4 while light is being entered into the core 3b1. In a case where light is being entered into each core of one of the two multicore fibers (3a, 3b), light may or may not be entered into each core of the other multicore fibers. In the example illustrated in FIGS. 1 to 3, a core portion is sequentially formed one by one between cores in the sequence of: core 3a1 (or 3b1)-->3a2 (or 3b4)-->3a3 (or 3b3)-->3a4 (or 3b2), and after a core portion is self-formed between each core, a core portion is self-formed between the next cores. The reason why light is entered in this way is because it can be prevented that each core portion, which is formed by light radiation between adjacent cores in each multicore fiber (3a, 3b), is formed in a state of bonding with each other, hence bonding failure of the core portions can be prevented.

A diameter of the core portion (2a1, 2b1, 2c1, 2d1) is preferably the same as the diameter of each core (3a1 to 3a4 or 3b1 to 3b4) of the multicore fiber (3a, 3b), and is preferably uniform in each core portion (2a1, 2b1, 2c1, 2d1) in the optical axis direction. A mode field diameter of each core portion (2a1, 2b1, 2c1, 2d1) is set to be the same as a mode field diameter of each core (3a1 to 3a4 or 3b1 to 3b4 of the multicore fiber (3a, 3b)) (7.4 μm to 8.5 μm).

The self-forming of a clad portion will be described next. After forming the core portions (2a1, 2b1, 2c1, 2d1), the inter-diffusion of monomers is generated in the clad portion forming resin in the photocurable resin 1 in the periphery of the core portions (2a1, 2b1, 2c1, 2d1), that is, in the interface between the core portions (2a1, 2b1, 2c1, 2d1) and the other portions of the photocurable resin 1. While the monomers are consumed and polymerized in the core portions (2a1, 2b1, 2c1, 2d1), monomers of the photocurable resin 1, other than the core portions (2a1, 2b1, 2c1, 2d1), are not polymerized, cured and consumed, hence the concentration gradient of monomers is generated in the periphery of the core portions (2a1, 2b1, 2c1, 2d1), and inter-diffusion progresses. In the present example, the photocurable resin, after forming the core portions (2a1, 2b1, 2c1, 2d1), is left alone for two minutes, then inter-diffusion of monomers is promoted.

Then, a laser beam in a wavelength band (λw=405 nm), which is the same as the wavelength band used for polymerizing the core portion forming resin, is irradiated into the core portions (2a1, 2b1, 2c1, 2d1) of each core (3a1 to 3a4 or 3b1 to 3b4) of the multicore fiber (3a, 3b), and is allowed to propagate inside the core portions (2a1, 2b1, 2c1, 2d1). Then, the light, having intensity equal to or higher than the intensity of the light used for polymerizing the core portion forming resin, is entered into the core portions (2a1, 2b1, 2c1, 2d1). Of course, th intensity is an intensity that can polymerize the clad portion forming resin.

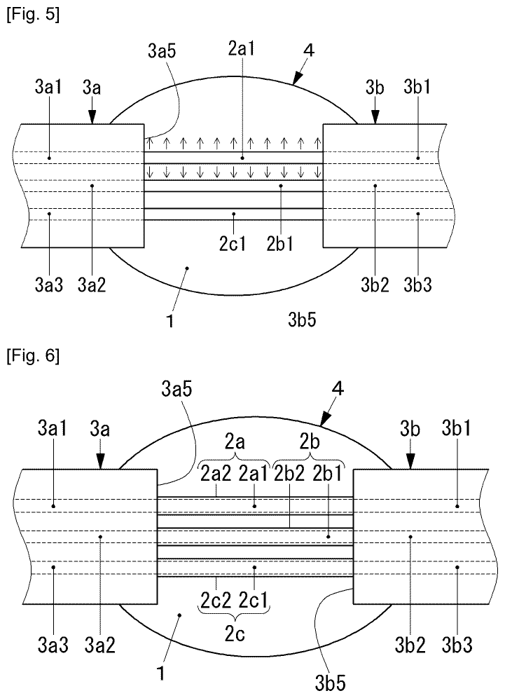

Further, the propagation of light continues and light leakage is generated from the core portions (2a1, 2b1, 2c1, 2d1) to the uncured clad portion forming resin around the core portions (2a1, 2b1, 2c1, 2d1). Then the clad portion forming resin around the core portions (2a1, 2b1, 2c1, 2d1) are polymerized and cured by the light leakage indicated by the arrows in FIG. 5, whereby the clad portions (2a2, 2b2, 2c2, 2d2) are self-formed in a state of surrounding the surface of the core portions (2a1, 2b1, 2c1, 2d1). The arrows in FIG. 5 indicate only the light leakage from one core portion 2a1, but the light leakage is generated also from the other core portions (2b1, 2c1, 2d1). The clad portion 2d2 is not illustrated here, but is a clad portion which is self-formed surrounding the surface of the core portion 2d1.

The refractive index nb of the self-formed clad portions (2a2, 2b2, 2c2, 2d2), after curing, satisfies nb<na, with respect to a refractive index na of the core portions (2a1, 2b1, 2c1, 2d1). Therefore, a plurality of self-forming optical waveguides (2a, 2b, 2c, 2d) are self-formed by the core portions (2a1, 2b1, 2c1, 2d1) and the clad portions (2a2, 2b2, 2c2, 2d2). The self-forming optical waveguide 2a is constituted of the core portion 2a1 and the clad portion 2a2. In addition, the self-forming optical waveguide 2b is constituted of the core portion 2b1 and the clad portion 2b2, the self-forming optical waveguide 2c is constituted of the core portion 2c1 and the clad portion 2c2, and the self-forming optical waveguide 2d is constituted of the core portion 2d1 and the clad portion 2d2.

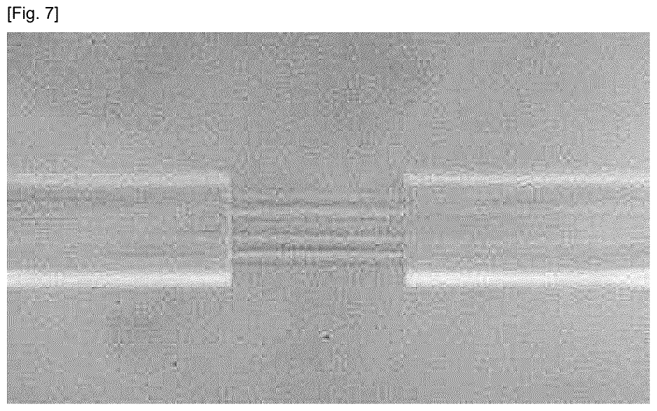

Finally an ultraviolet ray (UV) is uniformly applied from the periphery of the transparent container 4, so that all of the unreacted photocurable resin 1 is cured (see FIGS. 6 and 7).

The lights for forming the clad portions (2a2, 2b2, 2c2, 2d2) may be irradiated into all the core portions (2a1, 2b1, 2c1, 2d1) all at once from all the cores (3a1 to 3a4 or 3b1 to 3b4) of each multicore fiber (3a, 3b), or may be irradiated into each core portion (2a1, 2b1, 2c1, 2d1) one-by-one sequentially. It is preferable to enter the lights from all the cores (3a1 to 3a4 or 3b1 to 3b4) to all the core portions (2a1, 2b1, 2c1, 2d1) all at once, since a complicated irradiation time control is not necessary, and the time to form the clad portions (2a2, 2b2, 2c2, 2d2) can be shortened.

As described above, by forming the clad portions (2a2, 2b2, 2c2, 2d2) by light leakage from the core portions (2a1, 2b1, 2c1, 2d1), generation of curing shrinkage of the entire photocurable resin 1, excluding the core portions (2a1, 2b1, 2c1, 2d1), can be prevented, and only the clad portion forming resin can be cured when the clad portions (2a2, 2b2, 2c2, 2d2) are formed. Therefore, generation of stress in the entire photocurable resin 1 can be prevented, and deformation of the core portions (2a1, 2b1, 2c1, 2d1) can be suppressed, and an increase in light insertion loss to the core portions (2a1, 2b1, 2c1, 2d1) can be prevented.

Furthermore, by forming the clad portions (2a2, 2b2, 2c2, 2d2) are formed by light leakage, as mentioned above, the diameter and thickness of each clad portion can be controlled, and the optical characteristics and mechanical characteristics of the self-forming optical waveguides (2a, 2b, 2c, 2d) can also be stabilized.

Furthermore, in the present example, in the case of forming a plurality of self-forming optical waveguides (2a, 2b, 2c, 2d), curing of all the clad portions (2a2, 2b2, 2c2, 2d2) can be completed without applying UV from the periphery of the photocurable resin 1 when the clad portions (2a2, 2b2, 2c2, 2d2) are formed, hence an increase in light insertion loss to each core portion (2a1, 2b1, 2c1, 2d1) can be prevented.

After forming the self-forming optical waveguides (2a, 2b, 2c, 2d), light of 1550 nm wavelength is irradiated from each core (3a1 to 3a4) of the multicore fiber 3a into each optical waveguide (2a, 2b, 2c, 2d), and is propagated, and the optical output emitted with respect to the optical output of incident light is measured by a power meter, and the light insertion loss between the multicore fibers (3a, 3b) is measured.

Table 1 indicates the loss values. As indicated in Table 1, in all four optical waveguides (2a, 2b, 2c, 2d), the light insertion loss improved to be in the 0.2 dB to 1.2 dB range. In Table 1, the optical waveguide 2a is indicated as channel 1, the optical waveguide 2b as channel 2, the optical waveguide 2c as channel 3, and the optical waveguide 2d as channel 4. The length of each optical waveguide (2a, 2b, 2c, 2d) between the end faces (3a5, 3b5) of the two multicore fibers (3a, 3b) is 500 μm.

TABLE 1

| | Light insertion |
|---|---|
| Channel | loss (dB) |
| 1 | 0.8 |
| 2 | 1.0 |
| 3 | 0.2 |
| 4 | 1.2 |

The present invention is applicable not only to the method of manufacturing a self-forming optical waveguide between multicore fibers, but also to high density optical packaging fields, such as a method of manufacturing a self-forming optical waveguide between a multicore fiber and a silicon optical waveguide, or between a multicore optical fiber and a polymer optical waveguide.

### REFERENCE SIGNS LIST

1 Photocurable resin
2a, 2b, 2c, 2d Self-forming optical waveguide
2a1, 2b1, 2c1, 2d1 Core portion of self-forming optical waveguide
2a2, 2b2, 2c2, 2d2 Clad portion of self-forming optical waveguide
3a, 3b Multicore fiber
3a1, 3a2, 3a3, 3a4, 3b1, 3b2, 3b3, 3b4 Core of multicore fiber
3a5, 3b5 End face of multicore fiber
4 Transparent container
d Distance between each core of multicore fiber

1. A method of manufacturing a self-forming optical waveguide, comprising:
preparing two multi-core fibers, each of which comprises a photocurable resin and n number (n: 2 or greater natural number) of cores, wherein the photocurable resin comprises: a core portion forming resin which has a refractive index of na after polymerization and curing by irradiation of light in a predetermined wavelength band; and a clad portion forming resin which has a refractive index of nb, satisfying nb<na, after polymerization and curing by irradiation of light having an intensity equal to or higher than the intensity of the light irradiating into the core portion forming resin,
disposing the two multi-core fibers to face each other and disposing the photocurable resin between the multi-core fibers,
causing light having intensity that can polymerize only the core portion forming resin to irradiate into the photocurable resin from the two multi-core fibers sequentially, so that the core portion forming resin is polymerized and cured to form a core portion of the optical waveguide inside the photocurable resin, and then,
forming a clad portion, to self-form n number of optical waveguides inside the photocurable resin.
